(19) United States
(12) Patent Application Publication
(10) Pub. No.: US 2024/0266095 A1
(43) Pub. Date: Aug. 8, 2024

(54) RARE-EARTH MAGNET MATERIAL AND MAGNET

(71) Applicant: Murata Manufacturing Co., Ltd., Nagaokakyo-shi (JP)

(72) Inventors: Takashi YAMAZAKI, Nagaokakyo-shi (JP); Satoshi OGA, Nagaokakyo-shi (JP); Kazuki SATO, Nagaokakyo-shi (JP); Kazuhiro TAKAYAMA, Nagaokakyo-shi (JP)

(21) Appl. No.: 18/595,936

(22) Filed: Mar. 5, 2024

Related U.S. Application Data
(63) Continuation of application No. PCT/JP2022/034824, filed on Sep. 16, 2022.

(30) Foreign Application Priority Data
Oct. 1, 2021 (JP) 2021-163100

(51) Int. Cl. H01F 1/059; H01F 1/055

(52) U.S. Cl. CPC H01F 1/059; H01F 1/0551

(57) ABSTRACT

A rare-earth magnet material that includes: 7.0 atom % to 11.0 atom % of Sm; 11.0 atom % to 19.5 atom % of N; 69.5 atom % to 82.0 atom % of Fe; C; and a M-C crystal phase that includes the M and the C as main components, wherein the M is at least one element selected from Zr, Ti, Hf, V, Nb, Ta, Cr, Mo, and W, and a content of the M in the rare-earth magnet material is 1.6 atom % to 5.0 atom %.

### CROSS REFERENCE TO RELATED APPLICATIONS

The present application is a continuation of International application No. PCT/JP2022/034824, filed Sep. 16, 2022, which claims priority to Japanese Patent Application No. 2021-163100, filed Oct. 1, 2021, the entire contents of each of which are incorporated herein by reference.

### TECHNICAL FIELD

The present invention relates to a rare-earth magnet material and a magnet.

### BACKGROUND ART

As one of rare-earth magnetic materials, a samarium-iron-nitride-based magnetic material including samarium (Sm), iron (Fe), and nitrogen (N) has been known. The samarium-iron-nitride-based magnetic material is used as a source material for a bonded magnet, for example.

For example, PTL 1 discloses a powder magnet material having an alloy component of SmₓFe_{100-x-y}Nᵥ, SmₓFe_{100-x-y-v}M¹_{y}Nᵥ, or SmₓFe_{100-x-z-v}M²_{z}Nᵥ [M¹ represents Hf or Zr, M² represents one or two or more selected from Si, Nb, Ti, Ga, Al, Ta and C, 7≤x≤12, 0.5≤v≤20, 0.1≤y≤1.5, and 0.1≤z≤1.0].

On the other hand, PTL 2 discloses a SmFeN-based magnet material including: 7.0 to 12 atom % of Sm; 0.1 to 1.5 atom % of one or more elements selected from a group consisting of Hf, Zr, and Sc; 0.02 to 0.14 atom % of Si; 0.08 to 0.5 atom % of C; 10 to 20 atom % of N; 0 to 35 atom % of Co; and a remainder of Fe.
PTL 1: Japanese Patent Laid-Open No. 2002-57017
PTL 2: Japanese Patent Laid-Open No. 2018-46221

### SUMMARY OF THE INVENTION

PTL 1 describes the following problem: a magnetic property is improved by adding Zr or the like, but when an amount of addition of Zr is increased, a soft magnetic phase is precipitated to result in decreased coercive force (for example, paragraph 0022). Further, each of PTL 1 and PTL 2 describes the following problem: a residual magnetic flux density is improved by adding C to compensate for insufficient deoxidation at the time of source material molten production, but when a large amount of C remains in the SmFeN-based magnet, residual magnetization and coercive force are decreased (for example, paragraph 0024 of PTL 1 and paragraph 0013 of PTL 2).

It is an object of the present invention to provide a rare-earth magnet material and a magnet, each of which exhibits higher coercive force.

A rare-earth magnet material according to an aspect of the present invention includes: 7.0 atom % to 11.0 atom % of Sm; 11.0 atom % to 19.5 atom % of N; 69.5 atom % to 82.0 atom % of Fe; C; and a M-C crystal phase that includes the M and the C as main components, wherein the M is at least one element selected from Zr, Ti, Hf, V, Nb, Ta, Cr, Mo, and W, and a content of the M in the rare-earth magnet material is 1.6 atom % to 5.0 atom %.

The rare-earth magnet material may further include Co, wherein a content of Co may be 5 atom % or less.

A magnet according to the present invention includes: a binder; and any rare-earth magnet material described above, the rare-earth magnet material being dispersed in the binder.

According to each of the rare-earth magnet material and magnet of the present invention, higher coercive force can be achieved.

### BRIEF DESCRIPTION OF THE DRAWING

The FIGURE shows an observation image by a transmission electron microscope (TEM) and an element mapping image by energy dispersive X-ray spectroscopy (EDX) in each of an Example 2 and a Comparative Example 1.

### DETAILED DESCRIPTION OF THE PREFERRED EMBODIMENTS

A rare-earth magnet material of the present invention includes samarium (Sm), iron (Fe) and nitrogen (N), and includes M (which is at least one selected from Zr, Ti, Hf, V, Nb, Ta, Cr, Mo, and W) and C.

By adding M and C at the same time in this way, it is possible to obtain a multi-component system in which the order of crystal lattice is likely to be disturbed due to coexistence of the elements having different physical properties, and it is possible to decrease heat of mixing the constituent elements to attain a state in which the elements are likely to coexist. Further, the order of the crystal lattice composed of Sm, Fe, and the like is likely to be disturbed due to the coexistence of C, which has an atomic radius smaller than those of the other elements and is likely to enter the crystal lattice. In view of the above, by adding M and C at the same time, an amorphous thin strip forming ability is greatly improved. This effect promotes a quenched thin strip to be amorphous as described below so as to reduce crystal precipitation in the quenched thin strip, with the result that a coarse crystallite is suppressed from being generated due to heat treatment and high coercive force is achieved. On the other hand, when the content of C is large, C is distributed to a phase other than the main phase during cooling, thereby forming a M-C phase as described below. Thus, the coercive force can be higher.

In the rare-earth magnet material of the present embodiment, the crystal phase (M-C phase) including M and C as main components thereof can be precipitated. With the precipitation of the non-magnetic M-C phase having a low Fe concentration, a M-Fe phase, which is a soft magnetic phase generated when M is added, is suppressed from being precipitated. Thus, the coercive force is increased. Further, with the precipitation of the M-C phase that is a non-magnetic phase, a Sm—Fe—C phase or the like, which has low coercive force and is generated when C is added, is suppressed from being precipitated, with the result that the coercive force of the whole magnet is improved.

In order to precipitate such a M-C phase, for example, the content of M can be 1.6 atom % to 5.0 atom %, and is more preferably 2.0 atom % to 3.5 atom %. When the content of M is small, the M-C phase cannot be precipitated, whereas when the content of M is large, an amount of precipitation of the M-Fe phase that is a soft magnetic phase becomes large. Although the content of C is not defined, the content of C can be 0.2 atom % to 2.0 atom %, and is more preferably 0.5 atom % to 1.5 atom %, for example. When the content of C is small, the M-C phase may not be precipitated, whereas when the content of C is large, a Sm—Fe—C phase or the like may be precipitated to result in a decreased magnetic property. It should be noted that when the content of C is less than 0.5 atom % (for example, 0.1 atom % to less than 0.5 atom %), the M-C phase may not be precipitated; however, even in such a case, the coercive force becomes high as long as M and C are added at the same time as described above.

In the SmFeN-based magnetic powder according to the present invention, the content of Sm is, for example, 7.0 atom % to 11.0 atom %, and is preferably 9.0 atom % to 10.0 atom %. When the content of Sm is small, a phase such as a-Fe having low coercive force is likely to be precipitated, whereas when the content of Sm is large, the crystallite size of the main phase is likely to be large, thus resulting in decreased coercive force. The content of N can be 11.0 atom % to 19.5 atom %, and is preferably 12.0 atom % to 13.0 atom %, for example. In the SmFeN-based magnetic powder according to the present invention, the remainder can be Fe, and the specific content of Fe can be 69.5 atom % to 82.0 atom %, and is preferably 73 atom % to 79 atom %, for example.

The rare-earth magnet material of the present invention can include any other suitable element.

For example, the rare-earth magnet material of the present invention may include Co, and may include Co with a content of 5.0 atom % or less, preferably, a content of 1.0 atom % to 3.0 atom %. When the SmFeN-based magnetic powder includes Co, melt viscosity can be decreased when the magnetic material is produced by a below-described super-quenching method, with the result that super-quenching loss (source material loss when obtaining a thin strip) can be decreased to attain an improved yield (production efficiency). In the crystal structure of the SmFeN-based magnetic material, it is considered that Co can be present at the position of Fe with Co substituting for Fe; however, the present embodiment is not limited thereto.

For example, the rare-earth magnet material of the present invention may further include one or more of Al and Si. The content of Al is preferably 0.0 atom % to 10.0 atom %, and is more preferably 0.1 atom % to 5.0 atom %, for example. The content of Si is preferably 0.0 atom % to 1.0 atom %, and is more preferably 0.2 atom % to 0.6 atom %, for example. In the crystal structure of the SmFeN-based magnetic powder, it is considered that Al and/or Si can be present at the position(s) of Fe with Al and/or Si substituting for Fe; however, the present invention is not limited thereto.

Examples of other elements that can be added include at least one element selected from a group consisting of Nd, Pr, Dy, Tb, La, Ce, Pm, Eu, Gd, Ho, Er, Tm, Ym, Lu, Mn, Ga, Cu, Ni, and the like. When such element(s) are present, the content thereof (total of the contents when a plurality of elements are present) can be, for example, 2.0 atom % or less, and, more specifically, can be 1.8 atom % or less. When O is further contained as an inevitable impurity, the content thereof can be 10.0 atom % or less, and more specifically, can be 5.0 atom % or less.

It should be noted that the total of the contents of the respective elements of the rare-earth magnet material do not exceed 100 atom %. The total of the contents of all the elements that can be included in the rare-earth magnet material is theoretically 100 atom %.

The content (atom %) of each element in the rare-earth magnet material can be measured by inductively coupled plasma atomic emission spectroscopy (ICP-AES). Further, the content of each of O and N can be measured by an inert gas melting method.

The rare-earth magnet material of the present invention may have any suitable shape. For example, the rare-earth magnet material can be in the form of a magnetic powder having a particle size of about 1 to 300 μm. Further, a bonded magnet of the rare-earth magnet material can be obtained by mixing the rare-earth magnet material with a binder such as a resin or plastic and forming it into a predetermined shape and solidifying it.

The rare-earth magnet material of the present invention can be produced by, for example, a super-quenching method. The super-quenching method can be performed as follows. First, a mother alloy is prepared in which source metals for the rare-earth magnet material are mixed at a desired composition ratio. The mother alloy is melted (brought into a molten state) in an argon atmosphere and is sprayed onto a single roll that is being rotated (at, for example, a peripheral speed of 30 to 100 m/s), thereby super-quenching it to obtain a thin strip (or ribbon) composed of the alloy. The thin strip is pulverized to obtain a powder (having a maximum particle size of 250 μm or less, for example). The obtained powder is subjected to heat treatment under an argon atmosphere at a temperature equal to or higher than a crystallization temperature (for example, at 650 to 850° C. for 1 to 120 minutes).

Next, the powder having been through the heat treatment is subjected to nitriding treatment. The nitriding treatment can be performed in such a manner that the powder having been through the heat treatment is subjected to heat treatment under a nitrogen atmosphere (for example, at 350 to 600° C. for 120 to 960 minutes). However, the nitriding treatment can also be performed under any appropriate condition using, for example, an ammonia gas, a mixed gas of ammonia and hydrogen, a mixed gas of nitrogen and hydrogen, or other nitrogen source materials. The rare-earth magnet material of the present invention is obtained as a powder having through the nitriding treatment.

The rare-earth magnet material thus obtained can have a fine crystal structure. The average size of the crystal grains thereof may be 10 nm to 1 μm and is preferably 10 to 200 nm, for example; however, the present invention is not limited thereto.

Although the rare-earth magnet material and magnet in one embodiment of the present invention have been described in detail above, the present invention is not limited to such an embodiment.

### Example

Hereinafter, examples of the present invention will be described. It should be noted that the present invention is not limited only to these examples.

### Production of Examples and Comparative Examples

In order to obtain each of alloy compositions shown in Table 1, source metals were mixed at a ratio corresponding to the composition, and were melted in a high-frequency induction heating furnace, thereby preparing a mother alloy. This mother alloy was melted under an argon atmosphere and was sprayed onto a Mo roll rotating at a peripheral speed of 70 m/s for the sake of super-quenching, thereby obtaining a thin strip. The thin strip was pulverized to obtain a powder having a maximum particle size of 32 μm or less (sieved using a sieve having an opening of 32 μm).

The obtained powder was subjected to heat treatment under an argon atmosphere at 665 to 755° C. for 10 minutes. Next, the powder having been through the heat treatment was subjected to heat treatment at 405 to 535° C. for 8 hours under a nitrogen atmosphere for the sake of nitriding. As the nitrided powder, each of samples of rare-earth magnet materials according to the Examples and Comparative Examples was obtained.

Each of Examples 1 to 16 and Comparative Examples 2 to 5 includes C necessary to generate the M-C phase, whereas Comparative Example 1 does not include C necessary to generate the M-C phase.

Among Examples 1 to 4, the contents of Zr are changed with the contents of the other elements being the same.

Each of Examples 5 and 6 is based on the composition of Example 2 with the content of Sm being increased or decreased.

Each of Examples 7, 8, and 9 includes Nb, Ti, or Cr as element M for generating the M-C phase.

Each of Examples 10 and 11 is based on the composition of Example 3 with Co being added.

Each of Examples 12 and 13 is based on the composition of Example 3 with Al being added.

Each of Examples 14 and 15 is based on the composition of Example 3 with Si being added.

Example 16 is based on the composition of Example 4 with the content of N being increased.

Comparative Example 1 is based on the composition of Example 3 and does not include a necessary amount of C to generate the M-C phase.

Each of Comparative Examples 2 and 3 is based on the composition of Example 2 with the content of Sm being changed.

Each of Comparative Examples 4 and 5 is based on the composition of Example 2 with the content of Zr being changed.

Comparative Example 6 is based on the composition of Example 11 with the content of Co being increased.

TABLE 1

| | Sm | Fe | Co | Zr | Nb | Ti | Cr | Si | Al | N | C |
|---|---|---|---|---|---|---|---|---|---|---|---|
| Example 1 | 8.5 | Bal. | — | 1.5 | — | — | — | — | — | 11 | 0.7 |
| Example 2 | 8.5 | Bal. | — | 2.0 | — | — | — | — | — | 11 | 0.2 |
| Example 3 | 8.5 | Bal. | — | 3.0 | — | — | — | — | — | 12 | 1.7 |
| Example 4 | 8.5 | Bal. | — | 4.5 | — | — | — | — | — | 12 | 1.4 |
| Example 5 | 7.0 | Bal. | — | 2.0 | — | — | — | — | — | 12 | 0.6 |
| Example 6 | 11.0 | Bal. | — | 2.0 | — | — | — | — | — | 13 | 0.6 |
| Example 7 | 8.5 | Bal. | — | — | 3.0 | — | — | — | — | 12 | 0.6 |
| Example 8 | 8.5 | Bal. | — | — | — | 3.0 | — | — | — | 12 | 0.6 |
| Example 9 | 8.5 | Bal. | — | — | — | — | 3.0 | — | — | 12 | 0.6 |
| Example 10 | 8.5 | Bal. | 1.0 | 3.0 | — | — | — | — | — | 12 | 0.6 |
| Example 11 | 8.5 | Bal. | 5.0 | 3.0 | — | — | — | — | — | 12 | 0.6 |
| Example 12 | 8.5 | Bal. | — | 3.0 | — | — | — | — | 0.5 | 12 | 0.6 |
| Example 13 | 8.5 | Bal. | — | 3.0 | — | — | — | — | 1.0 | 12 | 0.6 |
| Example 14 | 8.5 | Bal. | — | 3.0 | — | — | — | 0.2 | — | 13 | 0.6 |
| Example 15 | 8.5 | Bal. | — | 3.0 | — | — | — | 0.6 | — | 13 | 0.6 |
| Example 16 | 8.5 | Bal. | — | 4.5 | — | — | — | — | — | 19 | 0.6 |
| Comparative Example 1 | 8.5 | Bal. | — | 3.0 | — | — | — | — | — | 13 | Measurement |
| | | | | | | | | | | | Lower Limit |
| | | | | | | | | | | | or Less |
| Comparative Example 2 | 8.5 | Bal. | — | 1.2 | — | — | — | — | — | 13 | 0.6 |
| Comparative Example 3 | 8.5 | Bal. | — | 6.0 | — | — | — | — | — | 13 | 0.6 |
| Comparative Example 4 | 6.0 | Bal. | — | 3.0 | — | — | — | — | — | 13 | 0.6 |
| Comparative Example 5 | 12.0 | Bal. | — | 3.0 | — | — | — | — | — | 13 | 0.6 |
| Comparative Example 6 | 8.5 | Bal. | 10.0 | 3.0 | — | — | — | — | — | 13 | 0.6 |

(Unit: atom %)

### (Evaluation of Magnetic Property)

Each of magnetic properties of the Examples and Comparative Examples described above was evaluated. In the evaluation, coercive force Hcj was measured by a vibrating sample magnetometer (VSM) under conditions that the true density of each sample (powder) was 7.6 g/cm³ and no demagnetizing field correction was performed.

TABLE 2

| | Hc j |
|---|---|
| | (kA/m) |
| Example 1 | 1180 |
| Example 2 | 1560 |
| Example 3 | 1366 |
| Example 4 | 1226 |
| Example 5 | 1260 |
| Example 6 | 1178 |
| Example 7 | 1459 |
| Example 8 | 1226 |
| Example 9 | 1151 |
| Example 10 | 1661 |
| Example 11 | 1167 |
| Example 12 | 1459 |
| Example 13 | 1226 |
| Example 14 | 1295 |
| Example 15 | 1317 |
| Example 16 | 1090 |
| Comparative Example 1 | 923 |
| Comparative Example 2 | 1006 |
| Comparative Example 3 | 1035 |
| Comparative Example 4 | 823 |
| Comparative Example 5 | 974 |
| Comparative Example 6 | 861 |

In Example 1, M and C are added and C necessary to generate the M-C phase is included, thereby exhibiting coercive force higher than that of Comparative Example 1. Each of Examples 2 and 3 is based on the composition of Example 1 with the content of Zr being increased. The coercive force in Example 2 was highest, whereas in each of Examples 3 and 4 in each of which the content of Zr is higher than that of Example 2, the coercive force was lower than that of Example 2. Further, the coercive force of each of Comparative Example 2 in which the content of Zr is lower than that of Example 1 and Comparative Example 3 in which the content of Zr is higher than that of each of Examples 3 and 4 is lower than those of Examples 1 to 4.

In Example 5 in which the content of Sm is increased as compared with Example 1, the coercive force was increased as compared with Example 1, whereas in Example 6 in which the content of Sm was decreased, the coercive force was decreased as compared with Example 1. Further, the coercive force in each of Comparative Example 4 in which the content of Sm is smaller than that of Example 5 and Comparative Example 5 in which the content of Sm is larger than that of Example 6 is lower than those of Examples 5 and 6. In each of Examples 7 to 9, Nb, Ti, or Cr is included as element M for generating the M-C phase, and each of Examples 7 to 9 exhibits coercive force higher than that of Comparative Example 1 in which the M-C phase is not generated.

Each of Examples 10 and 11 is based on the composition of Example 3 with Co being added. When a small amount of Co is added, the coercive force is increased as in Example 10; however, when the amount of addition of Co is increased as in Example 11, the coercive force is decreased. Each of Examples 12 to 15 is based on the composition of Example 3 with Al or Si being added, and each of Examples 12 to 15 exhibits coercive force higher than that of Comparative Example 1. Example 16 is based on the composition of Example 4 with the content of N being increased. Example 16 in which the content of N is increased exhibits coercive force higher than that of Comparative Example 1.

Each of the samples obtained in the Examples and the Comparative Examples was processed by a focused ion beam and was examined through energy dispersive X-ray spectroscopy using a transmission electron microscope (TEM-EDX). Table 3 shows presence or absence of the M-C phase in each of the Examples and Comparative Examples as found from observation results on this occasion.

TABLE 3

| | M-C Phase |
|---|---|
| Example 1 | Present |
| Example 2 | Present |
| Example 3 | Present |
| Example 4 | Present |
| Example 5 | Present |
| Example 6 | Present |
| Example 7 | Present |
| Example 8 | Present |
| Example 9 | Present |
| Example 10 | Present |
| Example 11 | Present |
| Example 12 | Present |
| Example 13 | Present |
| Example 14 | Present |
| Example 15 | Present |
| Example 16 | Present |
| Comparative Example 1 | Not Present |
| Comparative Example 2 | Present |
| Comparative Example 3 | Present |
| Comparative Example 4 | Present |
| Comparative Example 5 | Present |
| Comparative Example 6 | Present |

In each of Examples 1 to 16 and Comparative Examples 2 to 6, it was confirmed that a crystal phase including Zr and C as main components was present. Further, in Example 7, it was confirmed that a crystal phase including Nb and C as main components was precipitated. In Example 8, it was confirmed that a crystal phase including Ti and C as main components was precipitated. In Example 9, it was confirmed that a crystal phase including Cr and C as main components was precipitated. In Comparative Example 1, each of such crystal phases was not confirmed.

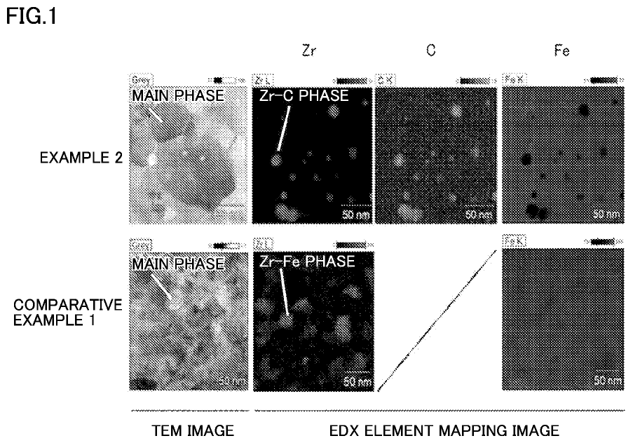

In each of Example 2 and Comparative Example 1 as representative examples, the obtained powder was processed by a focused ion beam, and an observation image by a transmission electron microscope (TEM) and an element mapping image by energy dispersive X-ray spectroscopy (EDX) were obtained as shown in FIG. 1.

In comparison between the EDX mapping images of Example 2 and Comparative Example 1, a phase (white-color portion) having a high Zr concentration is scattered in Comparative Example 1 as shown in FIG. 1. On the other hand, in Example 2, the position of the phase having a high Zr concentration coincides with the position of a phase (white-colored portion) having a high C concentration, and it is understood that a compound including Zr and C as main components is precipitated. That is, in Example 2, a compound including Zr and C as main components and having a low Fe concentration is precipitated. Thus, a soft magnetic phase including Zr and Fe as main components as in Comparative Example 1 is suppressed from being precipitated. Further, in Example 2, since Zr and C form the compound, no precipitation of Sm—Fe—C compound was observed. Thus, it is considered that the high coercive force is obtained in Example 2.

1. A rare-earth magnet material comprising:
7.0 atom % to 11.0 atom % of Sm;
11.0 atom % to 19.5 atom % of N;
69.5 atom % to 82.0 atom % of Fe;
C; and
a M-C crystal phase that includes the M and the C as main components, wherein the M is at least one element selected from Zr, Ti, Hf, V, Nb, Ta, Cr, Mo, and W, and a content of the M in the rare-earth magnet material is 1.6 atom % to 5.0 atom %.

2. The rare-earth magnet material according to claim 1, wherein the content of the M is 2.0 atom % to 3.5 atom %.

3. The rare-earth magnet material according to claim 1, wherein a content of the C is 0.2 atom % to 2.0 atom %.

4. The rare-earth magnet material according to claim 1, wherein a content of the Sm is 9.0 atom % to 10.0 atom %.

5. The rare-earth magnet material according to claim 1, wherein a content of the N is 12.0 atom % to 13.0 atom %.

6. The rare-earth magnet material according to claim 1, wherein a content of the Fe is 73.0 atom % to 79.0 atom %.

7. The rare-earth magnet material according to claim 1, further comprising Co, wherein a content of the Co is 5.0 atom % or less.

8. The rare-earth magnet material according to claim 7, wherein the content of the Co is 1.0 atom % to 3.0 atom %.

9. The rare-earth magnet material according to claim 1, further comprising one or more of Al and Si.

10. The rare-earth magnet material according to claim 9, wherein a content of the Al is 0.0 atom % to 10.0 atom %, and a content of the Si is 0.0 atom % to 1.0 atom %.

11. The rare-earth magnet material according to claim 1, further comprising at least one further element selected from a group consisting of Nd, Pr, Dy, Tb, La, Ce, Pm, Eu, Gd, Ho, Er, Tm, Ym, Lu, Mn, Ga, Cu, Ni, and wherein a total content of the at least one further element is 2.0 atom % or less.

12. A magnet comprising:
a binder; and
the rare-earth magnet material according to claim 1 dispersed in the binder.

13. The magnet according to claim 12, wherein the rare-earth magnet material is in a form of a magnetic powder having a particle size of 1 to 300 μm.

14. The magnet according to claim 12, wherein the content of the M in the rare-earth magnet material is 2.0 atom % to 3.5 atom %.

15. The magnet according to claim 12, wherein a content of the C in the rare-earth magnet material is 0.2 atom % to 2.0 atom %.

16. The magnet according to claim 12, wherein a content of the Sm in the rare-earth magnet material is 9.0 atom % to 10.0 atom %.

17. The magnet according to claim 12, wherein a content of the N in the rare-earth magnet material is 12.0 atom % to 13.0 atom %.

18. The magnet according to claim 12, wherein a content of the Fe in the rare-earth magnet material is 73.0 atom % to 79.0 atom %.

19. The magnet according to claim 12, further comprising Co, wherein a content of the Co in the rare-earth magnet material is 5.0 atom % or less.

20. The magnet according to claim 12, wherein the rare-earth magnetic material further includes one or more of Al and Si.
